(19) United States
(12) Patent Application Publication
(10) Pub. No.: US 2026/0337068 A1
(43) Pub. Date: Oct. 29, 2026

(54) SEWAGE TREATMENT DEVICE AND METHOD FOR TREATING REVERSE OSMOSIS CONCENTRATE

(71) Applicant: Greentech Environment Co., Ltd., Beijing (CN)

(72) Inventors: Zehua LI, Beijing (CN); Xikun ZHU, Beijing (CN); Liyan ZHANG, Beijing (CN); Mengyuan DUAN, Beijing (CN); Kai SUN, Beijing (CN); Pengchuan ZHANG, Beijing (CN)

(21) Appl. No.: 19/698,947

(22) Filed: Jun. 5, 2026

(30) Foreign Application Priority Data
Aug. 8, 2025 (CN) 202511106150.5

(51) Int. Cl. C02F 1/52; B01D 61/10

(52) U.S. Cl. CPC C02F 1/5281; B01D 61/10; B01D 2311/08; C02F 2001/5218; C02F 2301/08

(57) ABSTRACT

A sewage treatment device, including a cylindrical housing and an agitator arranged at a central axis of the cylindrical housing. An interior of the cylindrical housing is divided into a first crystallization zone, a second crystallization zone including at least two sub-zones, a third crystallization zone and a clarification zone from bottom to top. Adjacent zones or sub-zones are separated by the first inclined plates and second inclined plates that are alternately arranged. A method for treating a reverse osmosis concentrate is also provided. The agitator is activated. The reverse osmosis concentrate is fed into the sewage treatment device. An antiscalant-removing agent and a crystal seed are added into the first crystallization zone. A flocculant is added into the third crystallization zone. The reverse osmosis concentrate sequentially flows through the crystallization zones and the clarification zone to obtain purified water.

### CROSS-REFERENCE TO RELATED APPLICATIONS

This application claims the benefit of priority from Chinese Patent Application No. 202511106150.5, filed on Aug. 8, 2025. The content of the aforementioned application, including any intervening amendments made thereto, is incorporated herein by reference in its entirety.

### TECHNICAL FIELD

This application relates to sewage treatment, and more particularly to a sewage treatment device and a method for treating a reverse osmosis concentrate.

### BACKGROUND

For the removal of hardness from reverse osmosis concentrate dominated by calcium sulfate hardness, multi-stage reverse osmosis concentration can be adopted. By fully utilizing the characteristic that the concentration product of calcium sulfate in the reverse osmosis concentrate is higher than its solubility product, a crystallization process is employed to directly precipitate calcium sulfate crystals, thereby achieving complete removal of permanent hardness. This converts water quality dominated by permanent hardness into that dominated by temporary hardness, and completely eliminates the need for sodium carbonate dosing. This method has numerous advantages. (1) It has low operating cost. Under the same hardness removal efficiency, the operating cost is only 10-15% of that using sodium carbonate. (2) The product is a crystalline solid with excellent dewaterability and low sludge moisture content of generally 5-10%. (3) The produced calcium sulfate has a purity of over 98% and can be used as a building material or raw material for cement production.

The calcium sulfate crystallization process requires control of effluent hardness to ensure no scaling of the crystallized effluent in the post-treatment process section. Chinese Patent Publication No. CN119038767A disclosed a method for treating a reverse osmosis concentrate, which solved a problem of high calcium hardness in the effluent by means of antiscalant remover control technology. However, a certain degree of supersaturation still exists in the effluent, because continuous crystallization itself is difficult to reach an equilibrium state, resulting in slow scaling in the subsequent treatment system and affecting the stable operation of the process.

Therefore, it is desirable to provide a novel sewage treatment device and method to reduce effluent hardness and thereby avoid scaling in the post-treatment process section.

### SUMMARY

An object of the disclosure is to provide a sewage treatment device and a method for treating a reverse osmosis concentrate, so as to solve the above technical problems. The sewage treatment device provided by the present disclosure achieves effective control of effluent hardness through zone control within a single crystallizer. When applied to the reverse osmosis concentrate with hardness primarily due to calcium sulfate, it can reduce the calcium hardness of the effluent to the greatest extent and avoid the risk of scaling in subsequent treatment processes. Moreover, the sewage treatment device provided by the present disclosure eliminates the need for multi-stage crystallizers in series and discharge systems, thereby effectively reducing the space occupation and investment cost.

In order to achieve the above object, the following technical solutions are adopted.

In a first aspect, this application provides a sewage treatment device, comprising:
a cylindrical housing; and
an agitator;
an interior of the cylindrical housing is sequentially divided into a first crystallization zone, a second crystallization zone, a third crystallization zone and a clarification zone from bottom to top; the second crystallization zone comprises at least two crystallization sub-zones; the first crystallization zone and the second crystallization zone are separated by one of first inclined plates; and the at least two crystallization sub-zones, the third crystallization zone and the clarification zone are sequentially separated from bottom to top by second inclined plates and the rest of the first inclined plates, wherein the second inclined plates and the first inclined plates are alternately arranged;
the first inclined plates are each in a conical shape, and are each coaxially connected to the agitator; a top of each of the first inclined plates is provided with a hole for the agitator to pass through; and a gap is provided between each of the first inclined plates and an inner wall of the cylindrical housing; the size of the hole shall be set so as not to affect the rotation and stirring of the agitator, and shall not be excessively large to prevent sewage from passing through the hole; and
each of the second inclined plates is in a shape of an inverted conical frustum, and is connected to the inner wall of the cylindrical housing; and a gap is provided between each of the second inclined plates and the agitator.

The sewage treatment device provided by the present disclosure adopts zone control within a single crystallizer. Adjacent zones or sub-zones are separated by the first inclined plates and second inclined plates that are alternately arranged, so that the sewage is fully mixed in each reaction zone and short-circuiting of the sewage can be avoided.

In some embodiments, the first crystallization zone is connected to the third crystallization zone through a first pipeline arranged outside the cylindrical housing, and a crystal circulation pump is arranged at the first pipeline.

In the present disclosure, the first pipeline is arranged to circulate and pump crystals from the first crystallization zone into the third crystallization zone, where the crystals serve as crystal seeds to promote crystallization of the sewage in the third crystallization zone.

In some embodiments, an included angle between each of the first inclined plates and the agitator is 45°-75°, for example, 45°, 50°, 55°, 60°, 65°, 70°, and 75°.

When the included angle between each of the first inclined plates and the agitator is within the above range, it can ensure that the grown crystals in each zone automatically return to the first crystallization zone through the inclined plates.

In some embodiments, an included angle between each of the second inclined plates and the cylindrical housing is 45°-75°, for example, 45°, 50°, 55°, 60°, 65°, 70°, and 75°.

When the included angle between each of the second inclined plates and the cylindrical housing is within the above range, it can ensure that the grown crystals in each zone automatically return to the first crystallization zone through the inclined plates.

In some embodiments, a projected area of each of the first inclined plates onto a plane perpendicular to the agitator is 75%-80% of a projected area of the cylindrical housing onto the plane, for example, 75%, 76%, 77%, 78%, 79%, and 80%.

When the size of the first inclined plates is within the above range, it can ensure that the sewage has suitable space to flow from bottom to top.

In some embodiments, a projected area of each of the second inclined plates onto the plane is 98%-98.5% of the projected area of the cylindrical housing onto the plane, for example, 98%, 98.2%, 98.4%, and 98.5%.

When the size of the second inclined plates is within the above range, can ensure that the sewage has suitable space to flow from bottom to top.

In some embodiments, the number of the at least two crystallization sub-zones is two, and two crystallization sub-zones are a first crystallization sub-zone and a second crystallization sub-zone.

In the present disclosure, the second crystallization zone comprises two crystallization sub-zones, which can ensure that the effluent hardness of the purified water obtained after the sewage passes through the sewage treatment device of the present disclosure is within a target range, thereby effectively reducing the effluent hardness and avoiding the risk of subsequent scaling.

In some embodiments, a volume ratio of the first crystallization zone to the first crystallization sub-zone to the second crystallization sub-zone to the third crystallization zone to the clarification zone is 3-4:1-2:1-2:1-2:1-2, such as 3:1:1:1:1, 3:2:2:2:1, 4:1:1:1:1, and 4:2:2:2:2.

In some embodiments, a portion of the cylindrical housing where the first crystallization zone is located is provided with a water inlet, a first feeding port and a crystal discharge port. The water inlet is configured for introducing the sewage, the first feeding port is configured for adding an antiscalant-removing agent and a crystal seed, and the crystal discharge port is configured for discharging grown and settled crystals.

In some embodiments, a portion of the cylindrical housing where the third crystallization zone is located is provided with a second feeding port. The second feeding port is configured for adding a flocculant.

In some embodiments, an upper end of the clarification zone is provided with a water outlet for discharging purified water.

In some embodiments, a lower end of the clarification zone is provided with a second pipeline for discharging solids, wherein the solids comprise crystal particles and flocculant particles.

In some embodiments, the agitator is provided with at least one blade in each of the first crystallization zone, the second crystallization zone and the third crystallization zone.

In some embodiments, a lower portion of the cylindrical housing is in an inverted conical shape, which is more favorable for discharging crystals.

In a second aspect, this application provides a method for treating a reverse osmosis concentrate, comprising: activating the agitator, feeding the reverse osmosis concentrate into the sewage treatment device, adding an antiscalant-removing agent and a crystal seed into the first crystallization zone, adding a flocculant into the third crystallization zone, and allowing the reverse osmosis concentrate to sequentially flow through the first crystallization zone, the second crystallization zone, the third crystallization zone and the clarification zone to obtain purified water.

In the method provided by the present disclosure, the reverse osmosis concentrate in the first crystallization zone is treated with the antiscalant-removing agent to destroy the antiscalant in the reverse osmosis concentrate, and the crystal seed is used to induce crystallization of the reverse osmosis concentrate. Large crystals precipitate and are discharged through the crystal discharge port. The reacted reverse osmosis concentrate enters the second crystallization zone, where crystallization is induced by small-sized crystals that have escaped from the first crystallization zone into the second crystallization zone. The reverse osmosis concentrate reacts in each sub-zone of the second crystallization zone and then enters the third crystallization zone, and the grown crystals automatically return to the first crystallization zone through the inclined plates via each sub-zone. The reverse osmosis concentrate entering the third crystallization zone is induced to crystallize by small-sized crystals escaping from the second crystallization zone into the third crystallization zone. At the same time, a flocculant is added to the third crystallization zone for flocculation reaction. At this stage, the reverse osmosis concentrate has reached the minimum supersaturation. The grown crystals automatically return to the second crystallization zone through the inclined plates. The reacted reverse osmosis concentrate then enters the clarification zone for solid-liquid separation to obtain the purified water. Small-sized crystals and flocculant particles that escape into the clarification zone settle and are discharged.

The method provided by the present disclosure is directed to reverse osmosis concentrate with hardness primarily due to calcium sulfate. By using the sewage treatment device of the present disclosure for zone treatment, calcium sulfate crystallization gradually reaches an equilibrium state, the calcium hardness of the effluent is minimized, and a calcium sulfate resource product is obtained. Moreover, the flocculant and coagulant aid jointly constitute the antiscalant-removing agent, and are added in separate zones, which can avoid mixing of calcium sulfate dihydrate crystals with the flocculant and ensure the purity of calcium sulfate dihydrate.

In some embodiments, the method further comprises:
transporting, by the crystal circulation pump, a primarily-treated reverse osmosis concentrate containing crystals from the first crystallization zone into the third crystallization zone through the first pipeline;
wherein a transport flow is 5-10% of a feeding flow.

In the present disclosure, the a primarily-treated reverse osmosis concentrate containing crystals in the first crystallization zone is transported into the third crystallization zone to circulate the crystals, and the transport flow is limited to the above range, so as to ensure the maintenance amount of the crystal seed in each crystallization zone while avoiding an increase in water hardness in the third crystallization zone due to excessive transport flow.

In some embodiments, the antiscalant-removing agent comprises polyaluminum chloride, polyferric sulfate or a combination thereof, and an addition amount of the antiscalant-removing agent is configured such that the concentration of the antiscalant-removing agent in the reverse osmosis concentrate is 140-200 mg/L, such as 140 mg/L, 160 mg/L, 180 mg/L, and 200 mg/L.

In some embodiments, the crystal seed is calcium sulfate dihydrate, and a mass-to-volume ratio of the crystal seed to the reverse osmosis concentrate is 10-20 g:100 mL, such as 10 g:100 mL, 12 g:100 mL, 14 g:100 mL, 16 g:100 mL, 18 g:100 mL, and 20 g:100 mL.

In some embodiments, the flocculant is polyacrylamide, and an addition amount of the flocculant is configured such that the concentration of the flocculant in the reverse osmosis concentrate is 1-2 mg/L, such as 1 mg/L, 1.2 mg/L, 1.4 mg/L, 1.6 mg/L, 1.8 mg/L, and 2 mg/L.

In some embodiments, a retention time of the reverse osmosis concentrate in the sewage treatment device is 1-1.5 h, such as 1 h, 1.2 h, 1.4 h and 1.5 h.

Compared to the prior art, the present disclosure has the following beneficial effects.

The sewage treatment device provided by the present disclosure adopts zone control within a single crystallizer, effectively solving the problem in terms of effluent hardness. When treating reverse osmosis concentrate with hardness primarily due to calcium sulfate, it can minimize the calcium hardness of the effluent and avoid the risk of scaling in subsequent treatment processes. Moreover, the sewage treatment device provided by the present disclosure eliminates the need for multi-stage crystallizers in series and the associated discharge systems, thereby effectively reducing the space occupation and investment cost.

### BRIEF DESCRIPTION OF THE DRAWINGS

The accompanying drawings, which are incorporated into and constitute part of this specification, are intended to illustrate the embodiments of the disclosure, and are used for explaining the principles of the disclosure in conjunction with the specification.

In order to illustrate the technical solutions in the embodiments of the present disclosure or in the prior art more clearly, the drawings needed in the description of embodiments or the prior art will be briefly introduced below. Obviously, for those of ordinary skill in the art, other drawings can be obtained based on these drawings without exerting creative efforts.

FIG. 1 is a structural diagram of a sewage treatment device in Embodiment 1 of the present disclosure; and

FIG. 2 shows calcium hardness results of a n-th (n≤1) sampling of an influent, a first crystallization zone, a first crystallization sub-zone of a second crystallization zone, a second crystallization sub-zone of the second crystallization zone and purified water in Embodiment 2 of the present disclosure.

In the drawings: 1—cylindrical housing; 2—agitator; 3—first crystallization zone; 4—second crystallization zone; 41—first crystallization sub-zone; 42—second crystallization sub-zone; 5—third crystallization zone; 6—clarification zone; 7—first inclined plate; 8—second inclined plate; 9—water inlet; 10—first feeding port; 11—crystal discharge port; 12—second feeding port; 13—water outlet; and 14—crystal circulation pump.

### DETAILED DESCRIPTION OF EMBODIMENTS

In order to understand the above objects, features and beneficial effects of the present disclosure more clearly, the technical solutions of the present disclosure will be further described below. It should be noted that, as long as there is no contradiction, the embodiments of the present disclosure and the features in the embodiments can be combined with each other.

Many specific details are set forth in the following description to facilitate the understanding of the present disclosure, but the present disclosure can also be implemented in other ways different from those described herein. Obviously, described herein are merely some embodiments of the present disclosure, rather than all embodiments.

### Embodiment 1

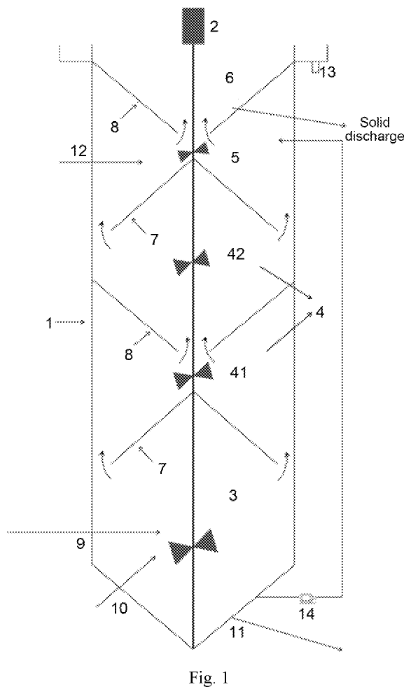

A sewage treatment device is provided, as shown in FIG. 1. The sewage treatment device specifically includes a cylindrical housing 1 and an agitator 2. The agitator 2 is arranged at a central axis of the cylindrical housing 1. A lower portion of the cylindrical housing 1 is in an inverted conical shape.

An interior of the cylindrical housing 1 is sequentially divided into a first crystallization zone 3, a second crystallization zone 4, a third crystallization zone 5 and a clarification zone 6 from bottom to top. The second crystallization zone includes two crystallization sub-zones, i.e., a first crystallization sub-zone 41 and a second crystallization sub-zone 42. The first crystallization zone 3 is connected to the third crystallization zone 5 through a first pipeline arranged outside the cylindrical housing 1. A crystal circulation pump 14 is arranged at the first pipeline. The agitator 2 is provided with at least one blade in each of the first crystallization zone 3, the second crystallization zone 4 and the third crystallization zone 5.

The first crystallization zone 3 and the second crystallization zone 4 are separated by one of first inclined plates 7. The first crystallization sub-zone 41, the second crystallization sub-zone 42, the third crystallization zone 5 and the clarification zone 6 are sequentially separated from bottom to top by second inclined plates 8 and the rest of the first inclined plates 7, where the second inclined plates 8 and the first inclined plates 7 are alternately arranged.

The first inclined plates 7 are each in a conical shape, and are each coaxially connected to the agitator 2. In an embodiment, the first inclined plates 7 are each coaxially fixed to the agitator 2, for example by welding. A top of each of the first inclined plates 7 is provided with a hole for the agitator 2 to pass through. A gap is provided between each of the first inclined plates 7 and an inner wall of the cylindrical housing 1. An included angle between each of the first inclined plates 7 and the agitator 2 is 75°, and a projected area of each of the first inclined plates 7 onto a plane perpendicular to the agitator is 77% of a projected area of the cylindrical housing 1 onto the plane.

Each of the second inclined plates 8 is in a shape of an inverted conical frustum, and is connected to the inner wall of the cylindrical housing 1. A gap is provided between each of the second inclined plates 8 and the agitator 2. An included angle between each of the second inclined plates 8 and the cylindrical housing 1 is 75°, and a projected area of the second inclined plate 8 onto the plane is 98.5% of the projected area of the cylindrical housing 1 onto the plane.

A volume ratio of the first crystallization zone 3 to the first crystallization sub-zone 41 to the second crystallization sub-zone 42 to the third crystallization zone 5 to the clarification zone 6 is 4:2:2:1:1.

A portion of the cylindrical housing 1 where the first crystallization zone is located is provided with a water inlet 9, a first feeding port 10 and a crystal discharge port 11. A portion of the cylindrical housing 1 where the third crystallization zone 5 is located is provided with a second feeding port 12. An upper end of the clarification zone 6 is provided with a water outlet 13. A lower end of the clarification zone 6 is provided with a second pipeline for solid discharge.

### Embodiment 2

A method for treating a reverse osmosis concentrate is provided, which is performed by using the sewage treatment device in Embodiment 1. The reverse osmosis concentrate is obtained by reverse osmosis concentration of wastewater from a chemical fiber industry, and has a sulfate concentration of 15,000-16,000 mg/L and a calcium hardness of 4,560-5,320 mg/L.

The method specifically includes the following steps.

The agitator 2 of the sewage treatment device is activated. The reverse osmosis concentrate is fed into the sewage treatment device through the water inlet 9. An antiscalant-removing agent and a crystal seed are added into the first crystallization zone 3 through the first feeding port 10. The antiscalant-removing agent is polyaluminum chloride with a concentration of 160 mg/L in the reverse osmosis concentrate. The crystal seed is calcium sulfate dihydrate with a mass-to-volume ratio of the crystal seed to the reverse osmosis concentrate of 10 g:100 mL. A flocculant is added into the third crystallization zone 5. The flocculant is polyacrylamide with a concentration of 1-2 mg/L in the reverse osmosis concentrate. The reverse osmosis concentrate flows sequentially through the first crystallization zone 3, the first crystallization sub-zone 41, the second crystallization sub-zone 42 and the third crystallization zone 5. At the same time, the primarily-treated reverse osmosis concentrate containing crystals is transported, by a crystal circulation pump 14, from the first crystallization zone 3 into the third crystallization zone 5 through a first pipeline, where a transport flow is 5%-8% of a feeding flow. The reverse osmosis concentrate is treated in different crystallization zones to reach a minimum saturation degree, and then enters the clarification zone 6 for solid-liquid separation to obtain purified water. A retention time of the reverse osmosis concentrate in the sewage treatment device is 1.5 h.

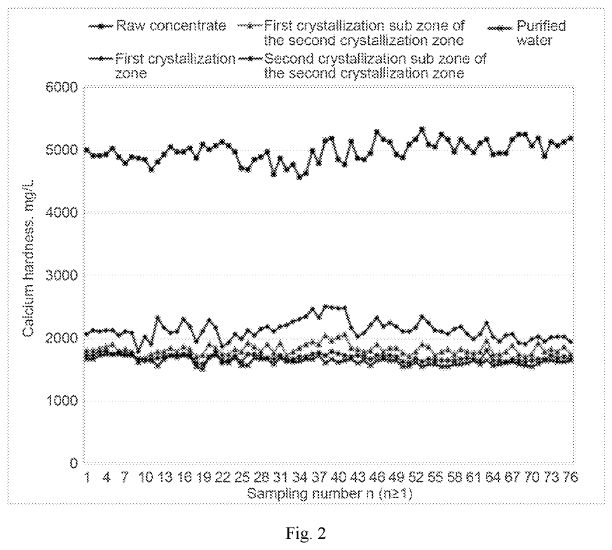

During operation, the influent hardness, water hardness in the first crystallization zone 3, water hardness in the first crystallization sub-zone 41, water hardness in the second crystallization sub-zone 42 and purified water hardness are tested respectively, with sampling twice a day. The calcium hardness results of the n-th (n≤1) sampling are shown in FIG. 2. The calcium hardness of the obtained purified water is 1,550-1,700 mg/L, with an average value of 1,629 mg/L.

### Comparative Example 1

A sewage treatment device is provided, which is basically the same as that in Embodiment 1, except that no zoning arrangement is provided inside the cylindrical housing 1 in the sewage treatment device of Comparative Example 1.

### Comparative Example 2

A method for treating a reverse osmosis concentrate is provided, which is performed by using the sewage treatment device of Comparative Example 1. The composition of the reverse osmosis concentrate is the same as that in Embodiment 2, and the retention time of the reverse osmosis concentrate in the sewage treatment device is 1.5 h. The calcium hardness of the obtained purified water is 1,760-1,950 mg/L, with an average value of 1,816 mg/L.

From the comparison between Embodiment 2 and Comparative Example 2, it can be seen that under the same retention time, when the reverse osmosis concentrate is treated using the sewage treatment device provided by the present disclosure, the calcium hardness of the total effluent purified water is 1,550-1,700 mg/L with an average value of 1,629 mg/L, which is significantly superior to the effluent obtained by single-stage crystallization in Comparative Example 2.

It should be noted that in this application, relational terms such as “first” and “second” are only used to distinguish one entity or operation from another entity or operation, and do not necessarily require or imply any actual relationship or order between these entities or operations. Furthermore, terms “comprise”, “include”, or any other variations thereof are intended to cover a non-exclusive inclusion such that a process, method, article, or apparatus includes not only those mentioned elements but also other elements not expressly listed, or elements that are inherent to such process, method, article, or apparatus. Without further limitation, an element defined by the statement “comprises a . . . ” does not exclude the presence of additional identical elements in a process, method, article, or apparatus that includes the mentioned element.

The embodiments described above are merely illustrative of the present disclosure, enabling those skilled in the art to understand or carry out the present disclosure. Various modifications to these embodiments will be obvious to those skilled in the art, and the generic principles defined herein can be practiced in other embodiments without departing from the spirit or scope of the disclosure. Therefore, the present disclosure is not to be limited to the embodiments described herein, but is to be accorded the widest scope consistent with the principles and novel features disclosed herein.

What is claimed is:

1. A sewage treatment device, comprising:
a cylindrical housing; and
an agitator;
wherein the agitator is arranged at a central axis of the cylindrical housing;
an interior of the cylindrical housing is sequentially divided into a first crystallization zone, a second crystallization zone, a third crystallization zone and a clarification zone from bottom to top; the second crystallization zone comprises at least two crystallization sub-zones; the first crystallization zone and the second crystallization zone are separated by one of first inclined plates; and the at least two crystallization sub-zones, the third crystallization zone and the clarification zone are sequentially separated from bottom to top by second inclined plates and the rest of the first inclined plates, wherein the second inclined plates and the first inclined plates are alternately arranged;
the first inclined plates are each in a conical shape, and are each coaxially connected to the agitator; a top of each of the first inclined plates is provided with a hole for the agitator to pass through; and a gap is provided between each of the first inclined plates and an inner wall of the cylindrical housing;
each of the second inclined plates is in a shape of an inverted conical frustum, and is connected to the inner wall of the cylindrical housing; and a gap is provided between each of the second inclined plates and the agitator; and
the first crystallization zone is connected to the third crystallization zone through a first pipeline arranged outside the cylindrical housing, and a crystal circulation pump is arranged at the first pipeline.

2. The sewage treatment device of claim 1, wherein an included angle between each of the first inclined plates and the agitator is 45°-75°;
an included angle between each of the second inclined plates and the cylindrical housing is 45°-75°;
a projected area of each of the first inclined plates onto a plane perpendicular to the agitator is 75%-80% of a projected area of the cylindrical housing onto the plane; or
a projected area of each of the second inclined plates onto the plane is 98%-98.5% of the projected area of the cylindrical housing onto the plane.

3. The sewage treatment device of claim 1, wherein the number of the at least two crystallization sub-zones is two, and two crystallization sub-zones are a first crystallization sub-zone and a second crystallization sub-zone.

4. The sewage treatment device of claim 3, wherein a volume ratio of the first crystallization zone to the first crystallization sub-zone to the second crystallization sub-zone to the third crystallization zone to the clarification zone is 3-4:1-2:1-2:1-2:1-2.

5. The sewage treatment device of claim 1, wherein a portion of the cylindrical housing where the first crystallization zone is located is provided with a water inlet, a first feeding port and a crystal discharge port;
a portion of the cylindrical housing where the third crystallization zone is located is provided with a second feeding port;
an upper end of the clarification zone is provided with a water outlet;
a lower end of the clarification zone is provided with a second pipeline for solid discharge;
the agitator is provided with at least one blade in each of the first crystallization zone, the second crystallization zone and the third crystallization zone; and
a lower portion of the cylindrical housing is in an inverted conical shape.

6. A method for treating a reverse osmosis concentrate, the method being performed using the sewage treatment device of claim 1, and the method comprising:
activating the agitator, feeding the reverse osmosis concentrate into the sewage treatment device, adding an antiscalant-removing agent and a crystal seed into the first crystallization zone, adding a flocculant into the third crystallization zone, and allowing the reverse osmosis concentrate to sequentially flow through the first crystallization zone, the second crystallization zone, the third crystallization zone and the clarification zone to obtain purified water.

7. The method of claim 6, further comprising:
transporting, by the crystal circulation pump, a primarily-treated reverse osmosis concentrate containing crystals from the first crystallization zone into the third crystallization zone through the first pipeline;
wherein a transport flow is 5-10% of a feeding flow.

8. The method of claim 6, wherein a retention time of the reverse osmosis concentrate in the sewage treatment device is 1-1.5 h.
